(19) United States
(12) Patent Application Publication
(10) Pub. No.: US 2018/0016160 A1
(43) Pub. Date: Jan. 18, 2018

(54) EUTECTIC FREEZE CRYSTALLIZATION SPRAY CHAMBER

(71) Applicant: EnisEnerGen, LLC, Henderson, NV (US)

(72) Inventors: Ben Enis, Henderson, NV (US); Paul Lieberman, Torrance, CA (US)

(73) Assignee: EnisEnerGen, LLC, Henderson, NV (US)

(21) Appl. No.: 15/209,666

(22) Filed: Jul. 13, 2016

(51) Int. Cl. C02F 1/22; B01D 9/00; C02F 1/52; C02F 103/10; C02F 101/12

(52) U.S. Cl. CPC C02F 1/22; B01D 9/0009; C02F 1/5236; C02F 2101/12; B01D 2009/0086; C02F 2103/10; C02F 2209/00; C02F 2001/5218

(57) ABSTRACT

A wastewater purifier has a chamber having an upper ingress end and a lower drain end, one or more wastewater nozzles connected to a wastewater source positioned near the ingress end, to produce wastewater droplets, a chilled air ingress positioned near the ingress end, connected to a chilled air source, positioned to permit the chilled air to mix with the wastewater droplets, a perforated accumulator near the drain end adapted to collect frozen droplets, a drain below the accumulator, and an egress for the chilled air near the drain end. A wastewater purifier has an elongated flow chamber having an upper portion and lower portion, one or more wastewater nozzles positioned near the upper portion, one or more egress vents positioned near the upper portion, a perforated accumulator at the bottom of the chamber, and a chilled air ingress connected between the upper and lower portions.

### BACKGROUND OF THE INVENTION

### 1. Field of Invention

The present invention relates to the field of crystallization spray chamber facilities for separating pollutants and wastewater.

### 2. Description of Related Art

The waste loads imposed on natural waters from industrial waste water disposal have begun to exceed the natural ability of the receiving waters to assimilate the contaminants. Natural treatment such as sedimentation, sunlight and oxygen aeration has given way to chemical treatment, precipitation, ozonolysis, chlorination and physical processes such as ion exchange, activated charcoal adsorption, reverse osmosis and electrodialysis. Freeze crystallization is one possibility for separating pollutants and wastewater that is receiving increased attention.

The waste loads imposed by fracking and mining are particularly difficult to treat because of the high concentrations, large values of Total Deposited Solids, large hydraulic diameter of the particulates and the large separation efficiencies that are required to treat the toxic portion of the wastewater. Freeze crystallization has shown promise in treatment of this type of wastewater in particular.

Chilled air provided an opportunity to extend the freeze crystallization of sprayed wastewater droplets from (1) Outdoor northern climates where extremely cold winters (colder than −10° F.) provided season long freezing of the bulk volume of waste water and thawing over the long spring and summer months to obtain separation of pollutants from wastewater and from (2) Indoor, any climate, spray chambers that used the impingement of liquid Freon and liquid waste water jets to obtain colder than −10 F temperatures in each droplet so that separation of pollutants from wastewater required only 0.5 second residence times rather than hour long residence times required for field volume and stirred tank bunk volume crystallization and phase separation.

The first research on eutectic freeze crystallization (EFC) was published in the 1970's by Stepakoff in 1974. He used direct cooling, where a refrigerant is directly added to the brine to achieve this. This poses some disadvantages, because there is another chemical introduced to the system.

Van der Ham, in 1999 was the first to use indirect cooling, and make a working crystallizer called the Cooled Disk Column Crystallizer. He proved that the separation of the ice and salt crystals using EFC is possible. The research was continued by Vaesen among others who scaled up the process to 100 L in the Scraped Cooled Wall Crystallizer during 2003.

Genceli, in 2008, scaled up the process to 220 L in the skid mounted third generation Cooled Disk Column Crystallizer, Rodriquez Pascual, during 2009 looked at some of the physical aspects of the heat transfer of the Crystallizer.

The next generation is a crystallizer now handles process streams on an industrial scale. The issue of removing scale from heat exchangers and removing the ice from the brine was studied by De Graaff in 2012.

The main advantages of the Freeze Crystallization process are the requirement of low energy and low temperature operation compared to thermal desalination. Other advantages are less scaling or fouling and fewer corrosion problems, ability to use inexpensive plastics or low-cost material, and absence of pre-treatment. The three broad classes of Freeze Crystallization process are: i) direct contact freezing, ii) indirect contact freezing, iii) vacuum freezing. Furthermore, there have been studies involving bulk freezing of a large volume of solution that takes hours to freeze, droplet freezing of millimeter size solution that takes seconds to freeze, the Freeze Crystallization process discussed herein uses direct contact of super chilled air with waste water droplets.

### Bulk Freezing (Stirred Tank)

Freeze Crystallization (FC) processes have been investigated and shown to have potential as environmentally friendly and sustainable water treatment methods, achieving a near zero waste by producing potable water and salts (in some instances pure salt(s)) from hyper-saline brines. A study by Randall and Nathoo reviews the history and current status of FC technologies for the treatment of Reverse Osmosis (RO) brines. The adoption of this technology in mainstream desalination brine treatment has been insignificant despite the fact that FC could have niche applications in the treatment of brines generated from membrane processes such as RO. The review also found that a hybrid technology approach, such as an integrated RO-FC process, can provide the optimum treatment solution from both an equipment capital and operating cost perspective. As an example, NIRO has built a commercial water desalination plant in the Netherlands for Shell and processes 140,000 million tons annually (MTA) of waste water. It achieves less than 50 ppm TDS purity.

### Outdoor Spray Freezing

The technique of spray freezing relies on the physics of a freezing droplet of water and ice crystal formation at the core and concentrating contaminants in unfrozen liquid on the surface of the solid core. Done properly, spray freezing can be an economical, efficient and environmentally friendly component of a larger water treatment system. Generally, as a droplet of impure water freezes, the impurities are pushed away from the ice crystallization front, which generally commences in the interior of the water droplet, resulting in a liquid with a higher contaminant concentration on the surface than the core, which is often nearly pure ice.

The freezing point of the remaining impure water occurs at a lower temperature as this process continues, and as time passes, more ice is formed and the contaminants become more concentrated in the remaining unfrozen liquid. This unfrozen liquid containing a greater concentration of contaminants drains from a spray ice deposit resulting in ease of removal of contaminants immediately following spraying.

When surrounding air is too cold or the droplet is too small, the droplet may freeze completely if exposed to the air for long enough, negating much of the benefit of the spray freezing technique. Additionally, as the ice melts during the warm seasonal spring thaw, the dissolved contaminants are preferentially flushed with the initial melt water increasing the purity of the remaining water.

The field application of this technique involves pumping contaminated water through a nozzle and spraying it into cold air. Adjustments are made to the trajectory of the water jet, the rate of pumping and the size of the droplets using nozzle adjustments, to control how completely the water freezes for a given air temperature and wind speed.

A field pilot scale experiment was conducted to evaluate the efficiency of spray freezing to remove dissolved chemicals from the tailings lake water at the Colomac Mine, NWT. For the pilot scale project approximately 30% of the water pumped was frozen, with the remaining water returned to the tailings pond as runoff. Analysis of the water collected from an ice core melted under controlled laboratory conditions showed dissolved chemical removal of 87-99% (depending on the chemical species) after 39% of the spray ice column had melted.

Laboratory tests provide some indication as to the utility of the method. Arsenic concentrations were reduced from approximately 19 μg/L to 5 μg/l (1 μg/l=1 part per billion). Cyanide had 99.2% removal but still remained at a concentration of approximately 350 μg/L. Approximately 60% of the treated water released at the end of the melt contained only 1-17% of the dissolved species. This melt water at the end of thaw would only require minor further treatment, which may significantly reduce overall treatment costs. Spray freezing technology has been used in ice building construction in cold regions and artificial snow making. The spray freezing process involves heat and mass transfer and ice nucleation. The freezing temperature of the sprayed water is influenced by many factors, such as droplet size (volume), ambient air temperature, and impurity content of the water. An experimental study was carried out to investigate the influence of the droplet size (volume) and the ambient air temperature on the ice nucleation temperature of the freely suspended droplets of different qualities—piggery wastewater, pulp mill effluent, and oil sands tailings pond water. The time required to initiate freezing in the freely suspended wastewater droplets was measured under various experimental conditions using video-image technology. The ice nucleation temperature of the droplets was predicted based on the required freezing time and the rate of heat and mass transfer.

### Indoor Spray Freezing (Spray Freezer)

In an example of indoor spray freezing, AVCO used impinging liquid jets of Freon and 20% NaCl salt solution. The intense mixing of the liquid jets resulted in a cloud of droplets wherein each droplet contained wastewater in its core and Freon outside of the core. Each droplet started its downward flight through the vertical chamber at 450 microns in diameter. The vaporizing Freon progressively froze the droplet. During the 0.5 second fall of the droplet through the 18 inch or 36 inch height glass chamber, an ice platelet of fresh water 120 microns in size deposited in a porous mass at the bottom of the chamber.

Based on the foregoing, there is a need in the art for a system of spray freezing that ensures consistency in the freezing process to enable separation of contaminants from the water, wherein the drop size and temperature is controlled to maintain the contaminated water in a liquid or semi-liquid state.

### SUMMARY OF THE INVENTION

A wastewater purifier has a chamber having an upper ingress end and a lower drain end, one or more wastewater nozzles connected to a wastewater source positioned near the ingress end, to produce wastewater droplets, a chilled air ingress positioned near the ingress end, connected to a chilled air source, positioned to permit the chilled air to mix with the wastewater droplets, a perforated accumulator near the drain end adapted to collect frozen droplets, a drain below the accumulator configured to provide an exit for liquid wastewater, and an egress for the chilled air near the drain end.

The wastewater purifier may have a housing around the chamber, made up of at least a partial double-wall around the chamber, the double wall defining an egress path, wherein the egress path is connected to the egress. The nozzle may be configured to provide droplets of a predetermined size. There may be a fresh water nozzle directed to the interior of the accumulator, the fresh water nozzle adapted to spray fresh water on frozen droplets collected within the accumulator.

The chilled air source may be selected from the group consisting of T-CAES turboexpander, TL-CAES turboexpander, compander and liquid nitrogen (LN2) trailer. In one embodiment, the wastewater droplets have a flight time of 3.75 to 7.05 seconds from being emitted from the nozzle to dropping into the receptacle, and there may be salt between the accumulator and the drain.

A wastewater purifier has an elongated flow chamber having an upper portion and lower portion, one or more wastewater nozzles positioned near the upper portion, one or more egress vents positioned near the upper portion, a perforated accumulator at the bottom of the chamber, and a chilled air ingress connected between the upper and lower portions, the ingress connected to a chilled air source.

The one or more nozzles may produce droplets of a predetermined size and project the droplet downwardly. The wastewater purifier may also have a collector positioned below the accumulator, wherein brine from the accumulator is collected in the collector. A fresh water nozzle may be directed to the interior of the accumulator, the fresh water nozzle adapted to spray fresh water on frozen droplets collected within the accumulator.

The wastewater droplets have a flight time of as short as 4.35 seconds for the large diameter droplets from being emitted from the nozzle to dropping into the receptacle. There may be salt between the accumulator and the collector. The collector may be connected to a drain, and the chilled air source may be selected from the group consisting of T-CAES turboexpander, TL-CAES turboexpander, compander and liquid nitrogen (LN2) trailer.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a cutaway view of the co-flow crystallization spray chamber, according to an embodiment of the present invention;

FIG. 2 is a cutaway view of the counter-flow crystallization spray chamber, according to an embodiment of the present invention;

FIG. 3 is an equilibrium phase diagram for sodium chloride solution, according to an embodiment of the present invention;

FIG. 4a is an energy balance calculation, according to an embodiment of the present invention;

FIG. 4b is a further energy balance calculation, according to an embodiment of the present invention;

FIG. 5 is graph showing residence time of a particle within the chamber, according to an embodiment of the present invention;

FIG. 6 is a comparison of prior art desalination methods;

FIG. 7 is a prior art chart showing energy efficiency of separation processes;

FIG. 8 is a prior art chart showing three methods of generating chilled air;

FIG. 9 is flow diagram for an EFCSC waste water purification system, according to an embodiment of the present invention;

FIG. 10 is graph showing power output at low intake temperature, according to an embodiment of the present invention;

FIG. 11 is a flow diagram for a FCSC facility, according to an embodiment of the present invention; and

FIG. 12 is a cross-section of a laboratory setup for an EFCSC facility, according to an embodiment of the present invention.

### DETAILED DESCRIPTION OF PREFERRED EMBODIMENTS

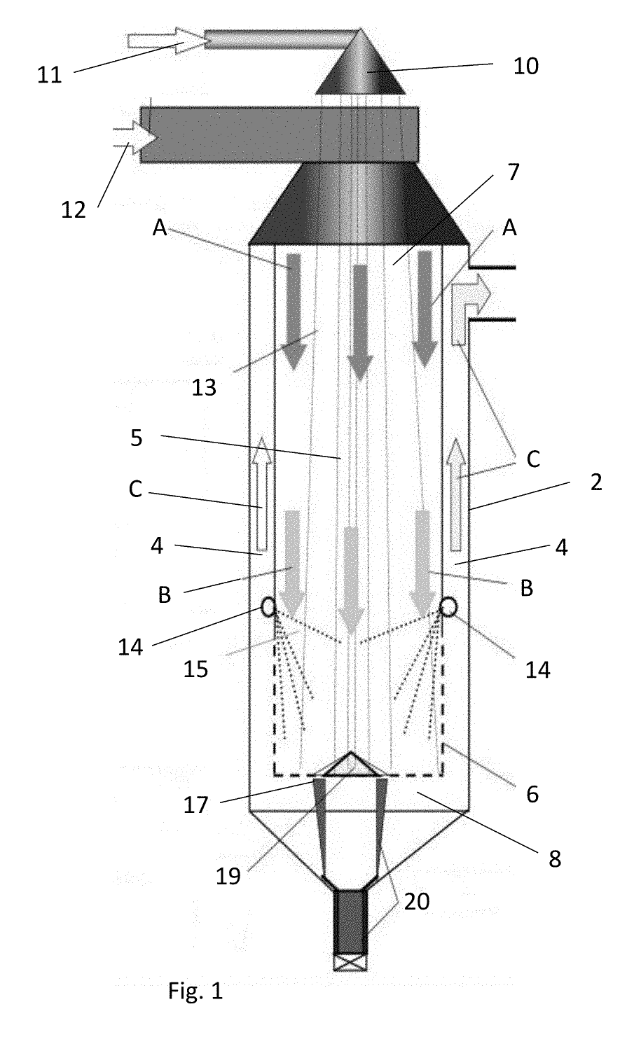

Preferred embodiments of the present invention and their advantages may be understood by referring to FIGS. 1-12, wherein like reference numerals refer to like elements.

Preferentially, the described Eutectic Freeze Crystallization Spray Chamber (EFCSC) facility uses −175° F. air temperatures and more than 3 seconds residence times in an enclosed facility that is useful hot or cold climates. Thus improved separation of the pollutant from the wastewater droplets that have been explored previously using warmer air temperatures (˜−10° F.) and shorter residence times to allow for nucleation, crystallization and separation than were explored previously at 0.5 second.

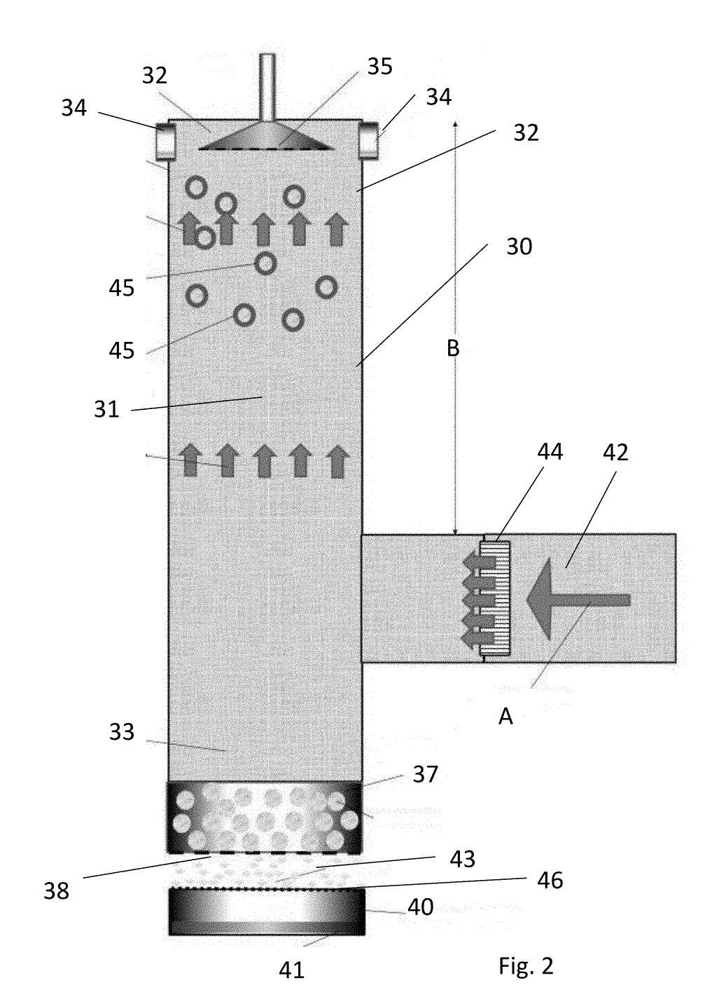

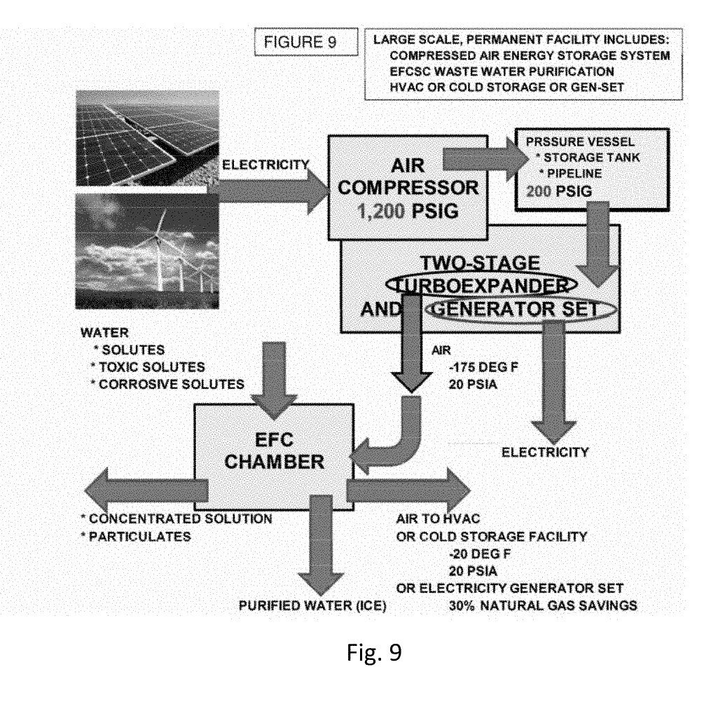

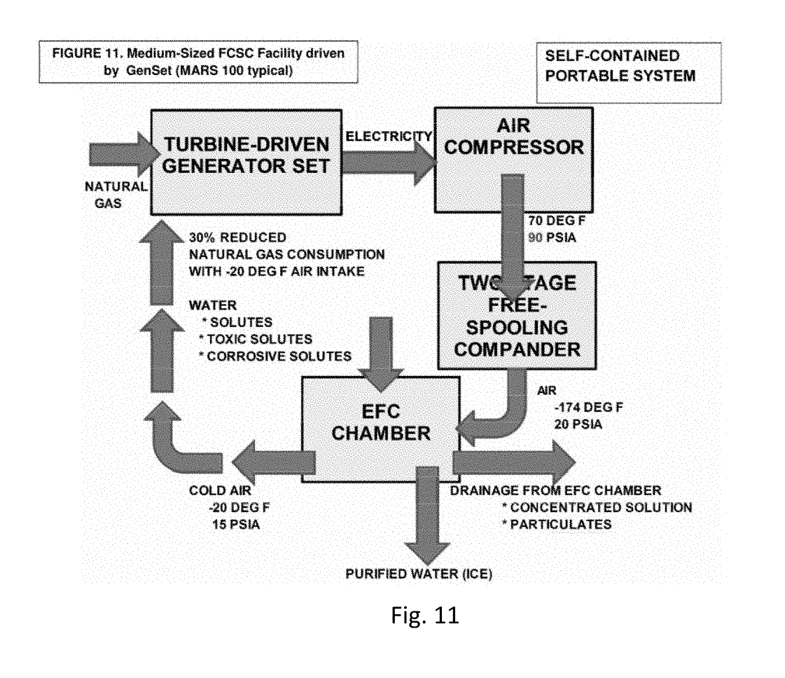

In FIGS. 1 and 9 in particular, the disclosure describes a co-flow EFCSC facility designed for more permanent installations that are located near a utility or can be viably supplied by a TL-CAES system or T-CAES system. In FIGS. 2 and 11 in particular, the disclosure also describes a counter-flow EFCSC facility for medium-sized facilities that can be driven by a utility or by a GenSet that obtains its super-chilled air from a two-stage, free-spooling, coupled turbocompressor and turboexpander. The key advantage of the EFCSC facility is that it has a low capital cost to build, operate and maintain; small footprint; small height; transportable by truck or train; and has a high separation efficiency.

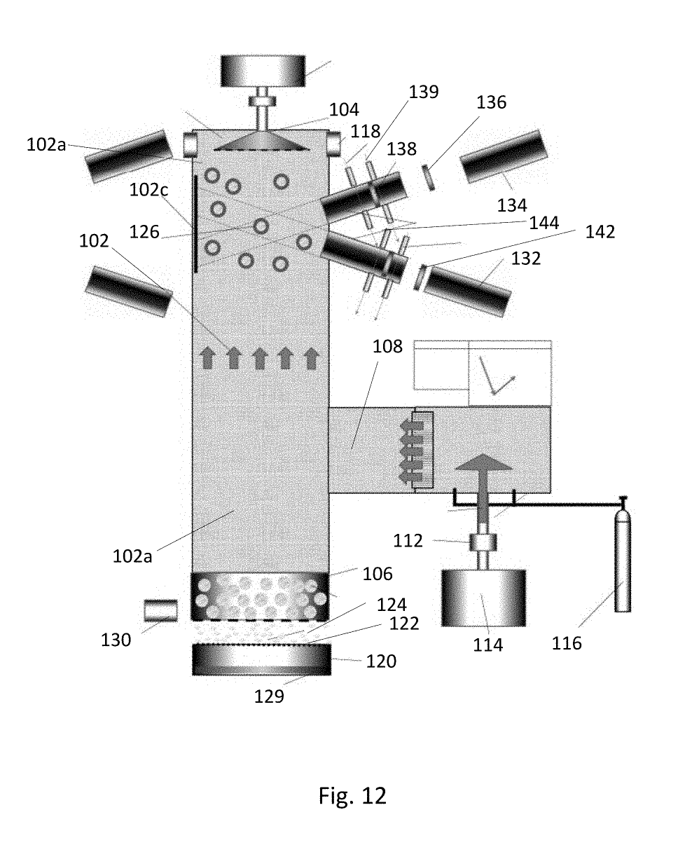

In FIG. 12 a universal testing facility that is desk-top in size and driven by liquid nitrogen vapors at −320° F. to evaluate the isolation efficiency for each new pollutant at each new concentration is described. The test data accumulated in this facility will provide the design parameters for the full scale facility. Since we are dealing with sprays from shower heads the scaling up of the test module to full scale is linear (FIG. 12).

There are two methods to obtain the required high mass flow of super-chilled air at −175° F.: (1) TL-CAES system or T-CAES system (FIG. 9) or (2) Compander (FIG. 11). A low mass flow of super-chilled gas can be obtained using a cryogenic dewar of, say, liquid nitrogen. In an example, the latent heat of vaporization of liquid nitrogen is 86 BTU/pound and the vaporization temperature of −320° F. can be combined in a mixing chamber with room temperature gaseous nitrogen from a manifold of K-Bottles of nitrogen, such as is shown in FIG. 12, to produce a prescribed gas temperature history to impinge on the wastewater droplet.

FIG. 1 shows a schematic of an example EFCSC facility designed for 95,000 gallons per day of wastewater purification. A housing 2 contains an inner chamber 5 for mixing wastewater spray and chilled air, and double walls define an outer egress path 4, surrounding, but separated from, the chamber 5. The egress path 4 may be present around the entire chamber 5, such that the housing 2 is a double-walled cylinder or container, or the egress path 4 may be present around only a portion of the chamber 5. The egress path 4 communicates with the chamber 5 at the drain end 8 of the chamber, wherein a perforated and removable basket 6 separates them but permits fluid communication.

The chamber 5 has a top (ingress end 7), a bottom (drain end 8) and containing the wastewater spray. The housing 2 has an ingress end 7 and drain end 8. One or more wastewater spray nozzles 10 are located at or near an ingress end 7 of the housing, and are connected by a connection 11 to a pressurized wastewater source (not shown). Near the ingress end 7 is air ingress 12 for introducing chilled air into the chamber 5. The nozzles 10 and air ingress are in close proximity to permit the mixing of the wastewater and chilled air. At the bottom of the chamber 5 is a perforated basket 6 for collecting ice droplets. Around the chamber is the egress path 4, which permits egress of the chilled air from the housing. The egress path 4 is connected to HVAC or cold storage in an embodiment. At the sides of the basket, and configured to spray into the basket, are one or more fresh water nozzles 14 to spray fresh water on frozen droplets (not shown) collected within the basket. Below the basket 6 is a drain 17 to collect liquid contaminated wastewater, and the wastewater/freshwater mixture. Above the drain may form an ice cone 19 to guide the wastewater into the drain, and below the drain is a waste pipe 20 for collecting the concentrated wastewater.

In an embodiment, the air ingress is located at a side of the ingress end oriented tangentially to the ingress end 7, to provide a rotational force to the incoming air to mix the air and water. In another embodiment the air ingress is directed downwardly.

In an embodiment, the chamber 5 is cylindrical of having a rectangular cross-section, wherein each end 7, 8 is flat, conical or pyramidal in shape, to encourage uniform mixing of the chilled air and wastewater at the ingress end, and collection of the contaminants at the drain end. If ease of construction is paramount, the chamber may be made from existing construction materials in a rectangular cross-section, with four planar walls interconnected at the corners and simple end termination wherein the nozzle(s) project through the top end, and the bottom end contains a drain.

In an embodiment, preferably the chilled air comes from one of four sources: T-CAES turboexpander, TL-CAES turboexpander, Compander or liquid nitrogen (LN₂) trailer. The LN2 trailer is the least economical driver but is useful on a laboratory scale.

In an embodiment, the nozzle 10 configuration controls the droplet 13 size, wherein a smaller droplet has a longer residence time within the chamber 5, with some examples given in the chart below. Full cone nozzles provide a uniform spray distribution of medium to large size drops resulting from their vane design which features large flow passages and control characteristics. Full cone nozzles provide a uniform spray distribution of medium to large size drops resulting from their vane design which features large flow passages and control characteristics, and are the most extensively used style in industry.

Within each type of spray pattern the smallest capacities produce the smallest spray drops, and the largest capacities produce the largest spray drops. Each nozzle shape will give a number distribution of droplet sizes wherein there are lots of smaller sized droplets and fewer larger sized droplets than the average size. Volume Median Diameter (VIVID) is based on the volume of liquid sprayed, therefore, it is a widely accepted measure. The chart below shows the range of drop sizes.

| | EFC | | DROPLET |
|---|---|---|---|
| DROPLET | CHAMBER | AREA | RESIDENCE |
| DIAMETER | HEIGHT* | EFCSC | TIME |
| (MICRONS) | (FT) | (SQFT) | (SEC) |
| 400 | 80 | 81 | 7.05 |
| 1200 | 80 | 81 | 3.75 |

In use, pressurized wastewater is forced through the nozzles 10 to emit into the tank 5 as a spray having droplets of a predetermined size. The wastewater spray 13 emitted from the nozzles (above 32F) passes through the chilled air that is being introduced into the tank by the air ingress, and the spray and chilled air combine to produce a combination, wherein the spray droplets are cooled by the chilled air. The chilled air may be produced from a turboexpander exhaust, and may be introduced at −175° F. at 44,000 SCFM. This combination occurs in region A and moves through the chamber 5 (in an embodiment, approximately 5 ft/sec). In region B the droplets are partially or wholly frozen due to prolonged contact with the chilled air, and moving faster (in an embodiment, approximately 7.8 ft/sec), and optionally fresh water 15 is sprayed on the frozen droplets by the fresh water nozzles 14 as a wash water to displace pond liquid from deposited layer of ice particles. In one embodiment, the fresh water is from thawed ice. In region C, the frozen droplets have collected in the basket 6 and the chilled air is exiting by the egress path 4. The combined wastewater droplet mixture moved down the chamber 5 towards the egress end 8. In region D, the chilled air egresses from the housing 2.

In an example, the facility is designed to treat 95,000 gallons of wastewater per day, wherein the wastewater must be brought from say 100° F. to −10° F. with a 144 BTU/pound for heat of fusion using 127,531 BTU/minute. Using a two-stage turboexpander and generator set, the system will generate approx. 4021.45 hp (3,000 kW) of electricity. As a by-product of the turbo-expansion process, with efficiency of 11 SCFM/HP, we have available 131,381 BTU/minute when this 44,236 SCFM (standard cubic feet per minute) air is brought from −175° F. to −10° F.

There is a slight excess of available chilling power compared to the required chilling power when we compare 131,381 BTU/minute to 127,531 BTU/minute. This is designed to take into account the chill-down of the facility to start the purification process and to continue the purification process considering heat transfer losses. The total time to use the chill down power is reduced by use of light weight and low heat capacity for the structural elements of the facility. The heat transfer losses are minimized by using the cold exhaust air to pass around the outside of the facility envelope.

Consider the sprayer at the top of the EFCSC facility. Prior art AVCO spray chambers used liquid Freon vaporization as the refrigerant generated 200 to 360 micron diameter wastewater droplets that grew 134 micron sized platelets of fresh ice in 0.5 seconds. Furthermore, the deposited ice platelets formed an accumulated mass that was porous and highly permeable (=0.453).

We have a larger temperature difference between air and wastewater droplet as well as more residence time. The 400 micron diameter wastewater droplet will have a 7.05 seconds residence time so that ice formation and separation is assured compared to the AVCO 0.5 seconds. However, we have more interest in the 1,200 micron diameter wastewater droplet size even though it has a short 3.75 seconds residence time because we can grow larger platelets of ice and a more porous accumulate of the ice buoyantly floating atop the mesh support screen so that the dense brine will drain through the accumulated snow mass and reduce the need for washing.

For example, for a 12 gallon per minute high volumetric flow of water through a full cone nozzle with 10-psi pressure drop across the nozzle face, the droplet size VMD=4,300 microns; for a 0.16 gallon per minute low volumetric flow of water through a hollow cone nozzle with 100-psi pressure drop across the nozzle face, the droplet size VMD=200 microns. Our interests are between 400 and 1,200 microns in diameter.

The velocity of the droplet exiting an orifice with a 10-psid pressure difference will be 22.8 ft/sec; at 40-psid it will be 45.7 ft/sec; and at 100-psid it will be 72 ft/sec.

Consider that the air moving downward through the crystallization chamber is on average 6.35 ft/sec and the 400 micron droplet has an additional terminal velocity of 5 ft/sec for a total of 11.35 ft/sec. Thus the spray will enter the top of the EFCSC facility at a higher speed than the air flow so these droplets will be rapidly decelerated with strong heat transfer.

Consider, in another example, that the air moving downward through the crystallization chamber is on average 6.35 ft/sec and the 1,200 micron droplet has an additional terminal velocity of 15 ft/sec for a total of 21.35 ft/sec. Thus, in order for the spray will enter the top of the EFCSC facility at a higher speed than the air flow so these droplets will be rapidly decelerated with strong heat transfer it is necessary to use the higher overpressure across the spray nozzle.

It is important that the droplet core temperature attain the eutectic freeze temperature just as the coated ice particle reaches the bottom of the chamber and rests on the mesh. Thus all three phases of the frozen wastewater will be present.

All the calculations are meant to show is that a 3.75 to 7.05 seconds flight time in the crystallization chamber should permit the complete mixing of the air and the droplets so that the final equilibrium temperature of the air will approach somewhat cooler than −6° F. and the droplets will approach warmer than −6° F. when deposited on the bottom of the crystallization chamber.

As the mass of draining snow accumulates in the perforated basket, continuous flow of small volume rate fresh water spray is maintained on the accumulating porous snow mass. Thus in addition to the natural drainage of the dense saline liquid from the top to bottom of the snow mass, the cold fresh water spray deposits on any remaining film on each snow crystal and flushes it downward. This step is required to achieve extremely high water purities.

Ice buoyantly floating atop the mesh support screen so that the dense brine will drain through the accumulated snow mass and reduce the need for washing. The removal of the snow mass can be done in batch form by regularly removing the entire perforated basket via a conveyor belt. Or can be accomplished continuously by using a screw that continuously moves the snow mass onto a conveyor belt.

It is important to properly handle the concentrated brine after it is collected. It should not be re-entered into the environment. In many applications the concentrated liquid brine can be further processed to recover useful products and additional potable water.

FIG. 2 shows the counter-flow EFCSC facility wherein the chilled input air is injected upward in the flow chamber past the downwardly-moving wastewater droplets. A housing 30 defines a chamber 31 that has an upper portion 32 and a lower portion 33, with one or more wastewater nozzles 35, connected to a wastewater source 36, at or near the upper portion, wherein the nozzles 35 produce wastewater droplets 45 of a relatively consistent size, and direct the droplet spray downwardly. The upper portion also has one or more air vents 34 to permit the egress of chilled air, which enters via a lower air ingress 42. A removable accumulator 37 is positioned in the lower portion to capture drained ice, and the accumulator 37 may be emptied and replaced when full. The perforated accumulator 37 drains into a collector 40 for collecting the contaminated brine 41. There is no air outlet in the lower portion for air to escape, only a drain for brine 41, used in some embodiments. In between the upper portion 32 and lower portion 33 is air ingress 42, connected to a chilled air source, which carries chilled air into the housing and towards the upper portion. In an embodiment, the chilled air source is turboexpander exhaust air with a temperature of approximately −175° F. In an embodiment, the chilled air passes through a honeycomb air flow straightener 44.

The wastewater spray is generally introduced in the upper portion by the nozzles 35 and droplets 45 move, by gravity and velocity imparted by the emitting nozzle, downwardly towards the lower portion 33. The droplets are above 32 F when emitted, but chilled air is introduced from the air ingress 42 at A and moves upwardly in the housing at B, toward the upper portion 32 where the chilled air exits through the air vents 34. The chilled air does not proceed downwardly in the housing 30 since there is no exit for the air. As the air rises, it passes by the droplets 35 which are descending, and cools the droplets 35, such that the droplets are partially or entirely frozen by the time they enter the lower portion 33. The frozen droplets 35 are accumulated in the accumulator 37, wherein the outer surface has brine exhibiting relatively higher concentration of contaminants. The outer surface thus has a higher melting temperature and may therefore be liquid when the droplets 35 reach the accumulator 37, in which case the brine, containing the contaminants, is collected within the collector 40 and may be drained to a centralized processing system (not shown). In an embodiment, below the accumulator is a grating 38 which holds larger ice particles back but permits smaller particles and brine to pass through. The collector has a finer grating 46 across its top, to permit only brine, but no ice particles, to pass through. Sandwiched between the larger grating 38 and finer grating 46 is salt, which combines with the smaller ice particles which pass through the larger grating 38, wherein the brine causes the salt to mix with the ice to increase separation efficiency through the washing procedure.

The washing procedure will start with a small amount of fresh water at near +32 deg F. Once the washing process has been started a portion of the thawed ice will be recycled back into the chamber to spray the accumulated porous mass of ice platelets. The fresh water spray striking the mass of ice platelets with only a very thin film of residue brine will force the film into draining as liquid brine as the original ice platelet grows in size. One or two such washes will be required for particularly toxic pollutants requiring strong separation efficiency.

In an embodiment, the housing is cylindrical, and is sealingly mated with the air ingress 42. In another embodiment, the housing has a square cross-section for ease of construction, with an inexpensive wall material.

In an embodiment, the nozzles are full cone nozzles providing a uniform spray distribution of medium to large size drops resulting from their vane design which features large flow passages and control characteristics. Full cone nozzles provide a uniform spray distribution of medium to large size drops resulting from their vane design which features large flow passages and control characteristics, and are the most extensively used style in industry. Within each type of spray pattern the smallest capacities produce the smallest spray drops, and the largest capacities produce the largest spray drops. Volume Median Diameter (VIVID) is based on the volume of liquid sprayed. Therefore, it is a widely accepted measure. The chart above shows the range of drop sizes possible by nozzle type.

There are several advantages to this embodiment even though it is technically more complex to that shown in FIG. 1. The overall height of the EFCSC facility is much smaller even though the residence time of the wastewater droplet can be as long as 4.35 seconds even for the 1,200 micron diameter wastewater droplet. The updraft velocity is approximately 15 ft/sec.

Essentially the wastewater droplet is maintained near the top of the EFCSC facility by the updraft as the droplet freezes. The very slow downward speed allows the frozen droplet (at say, −10° F.) with its liquid coated concentrated brine surface to fall down into the still volume at the bottom of the EFCSC facility. The downward injection velocity of the warm wastewater droplet into an upward moving cold air stream strongly enhances the heat exchange at the top of the EFCSC facility where the air stream is warmest. By the time the frozen wastewater droplet reaches the top of the still water region the frozen droplet is moving slowly but has the highest temperature difference being applied to its surface. It is where the incoming air is at −175° F. and the frozen droplet at −10° F. The still air chamber temperature at the bottom of the chamber can be better controlled to assure the eutectic temperature is maintained while the drainage and washing cycles are introduced.

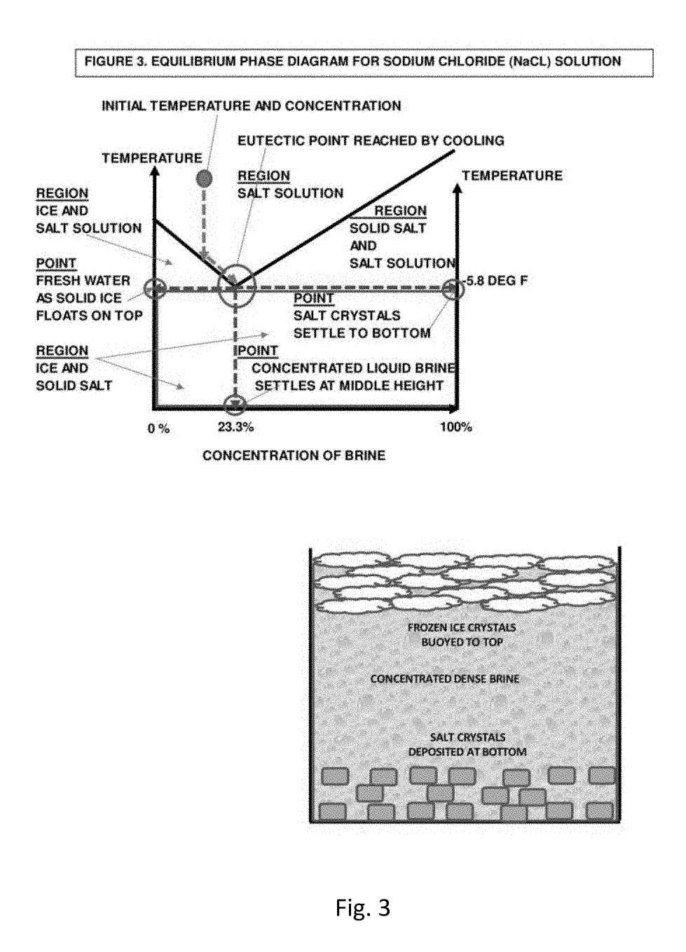

FIG. 3 shows the phase diagram for a salt (NaCl) solution with temperature and concentration coordinates. Consider a 6% solution of salt water. As the temperature is reduced from room temperature down to below 32° F., the entire solution remains liquid.

As the temperature is dropped further, and the phase boundary is encountered, ice nuclei form and grow within the cold liquid. Since each ice particle has less density than the surrounding brine it is buoyed to the top of the dense liquid brine. This process continues until a froth of these ice crystals appears at the top of the brine.

When the temperature of the liquid volume of brine is brought down to its eutectic temperature the layer of buoyant ice has grown to its maximum thickness. But also an additional event occurs. Individual dense salt crystals appear and settle to the bottom of the liquid brine. The remaining brine achieves a concentration known as the eutectic concentration. The drawing at the lower right depicts a brine solution at its eutectic temperature and eutectic concentration.

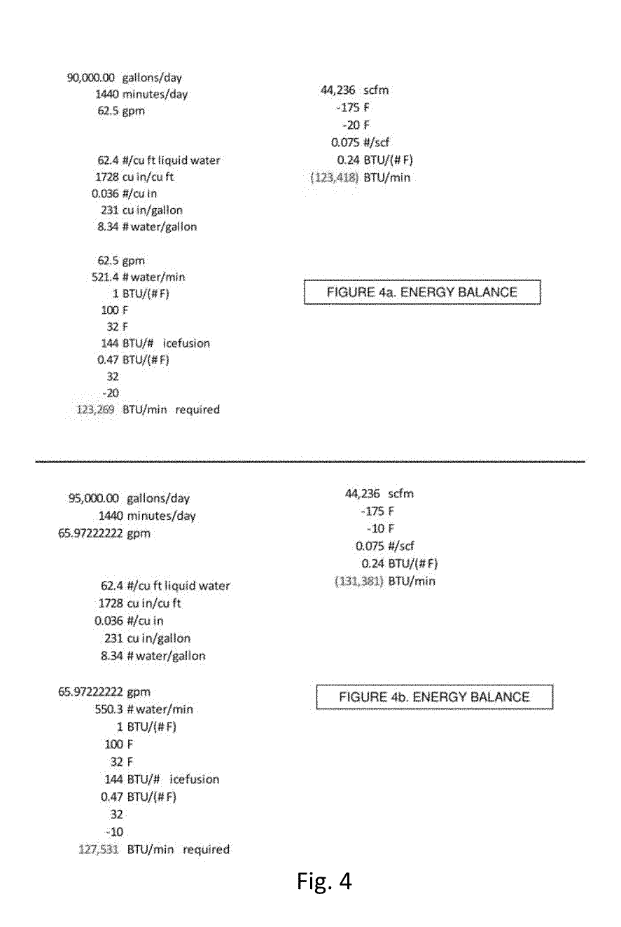

FIG. 4 shows the energy balance used to obtain the required mass flow of air at −175° F. in order to bring 90,000 gallons per day of wastewater to −20° F.; to bring 95,000 gallons per day of wastewater to −10° F. It is the former case that is used if there is to be a Gen-Set feeding electrical power to the required air compressors. This is an energy balance and assumes infinite time is available for the process and that all the water is in a stirred tank to assure perfect mixing. It is therefore an approximate calculation.

The heat transfer rate between cold air and warm wastewater droplet needs to be taken into account. A high relative velocity between droplet and air (i.e. a high Reynolds Number) as well as a high ratio of surface area to volume are required to assure the energy balance applies. Empirical data with similar environmental conditions has shown that for several wastewater solutions that 0.5 seconds was sufficient for a wastewater droplet to form ice nuclei, grow each ice nuclei and force the brine to the outer surface of the falling particle.

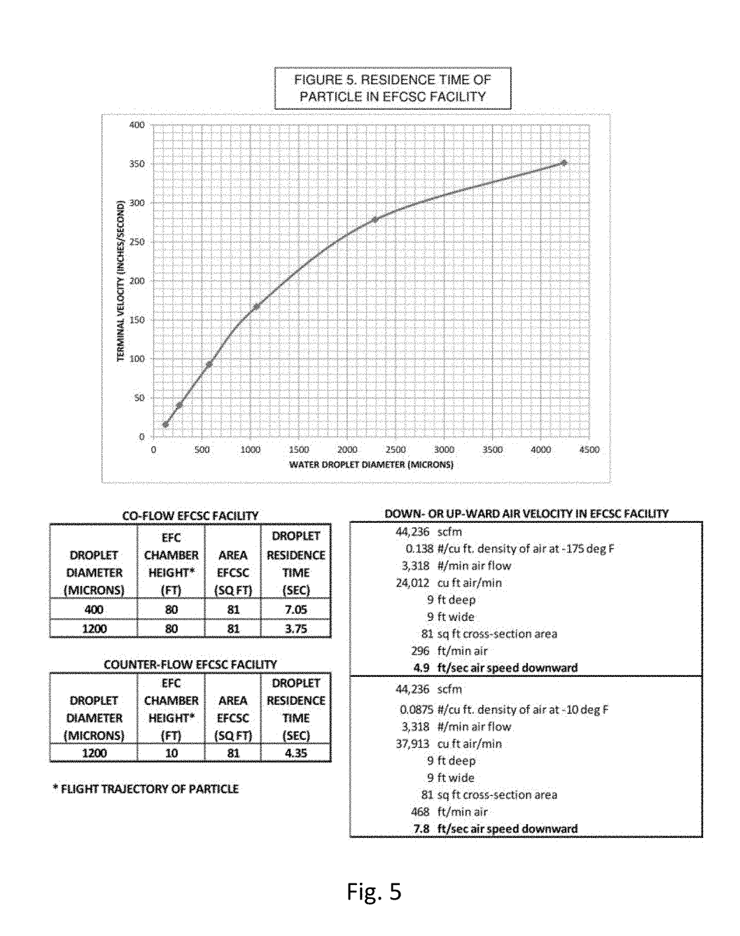

FIG. 5 shows the terminal velocity of a water droplet. The terminal velocity is that velocity achieved by a falling droplet in our gravitational field but resisted by an aerodynamic drag force generated by the falling velocity.

Initially, at the top of the EFCSC facility, the wastewater is a column of liquid with a pressure difference across the spray nozzle diameter, that generates a velocity and liquid column breakup into droplets of fixed diameter. However, during the downward flight of the droplet it encounters a downward wind in the co-flow facility or it encounters an upward wind in the counter flow facility. Thus the terminal velocity and facility wind velocity combine to yield the relative in the chamber of fixed length.

In the co-flow facility the facility is restricted to the height that can be transferred by rail or truck (or 90 feet). In the counter-flow facility the height requirement may be reduced by an order of magnitude. The chamber height divided by droplet relative velocity, results in the residence time of the droplet.

The velocity of the air in the chamber is determined by the flow of air that is to be handled in SCFM or pounds per minute. If we assume a cross-sectional area of the chamber as well as the air temperature at the top and bottom of the chamber, and combine that with the mass flow, we obtain the local velocity at the top and bottom of the chamber.

It is this series of calculations that produces the height and cross-sectional area of the co-flow and counter-flow chamber. Note that it was necessary to select the gallons per day of waste water as the starting point.

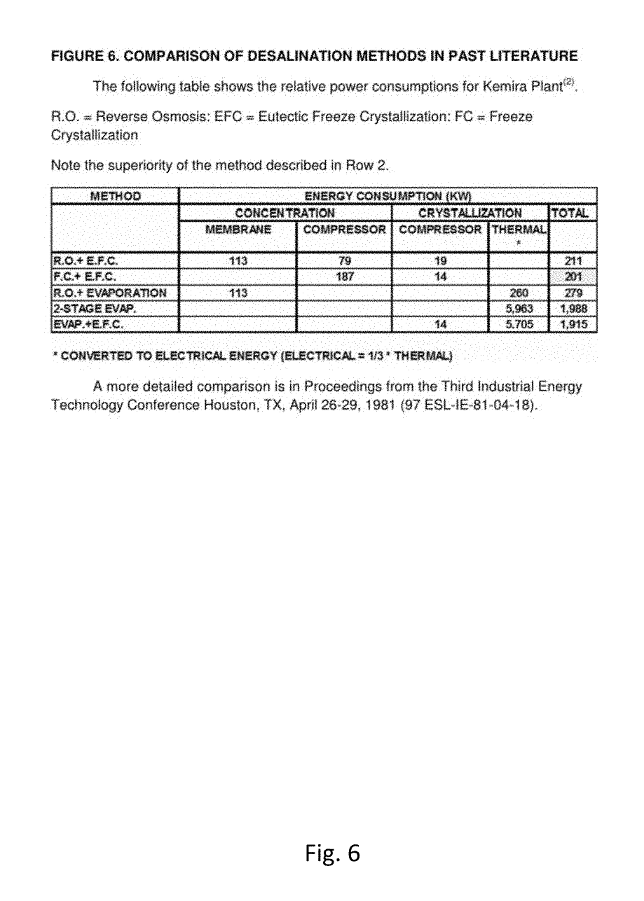

FIG. 6 shows freeze crystallization process is not as low in energy consumption as in the membrane processes, it has other advantages. The first advantage is that crystallization is usually a single equilibrium stage process. Since it operates at lower temperatures and the latent heats of crystallization are always less than vaporization, the entropy change is smaller for this process than for an evaporative process. The lower temperatures also lessen corrosion effects so that less expensive materials of construction are required. Very high separation factors are the rule with crystallizing processes, so the purity of the product is excellent.

Crystallization can generate clean water from saturated brines with TDS at concentrations up to 650,000 mg/L. Crystallization is often paired with other treatment processes that are more energy efficient at removing lower TDS concentrations in water. Crystallizers are seldom applied to low-TDS water sources because of their high operational energy input requirements and subsequent treatment costs.

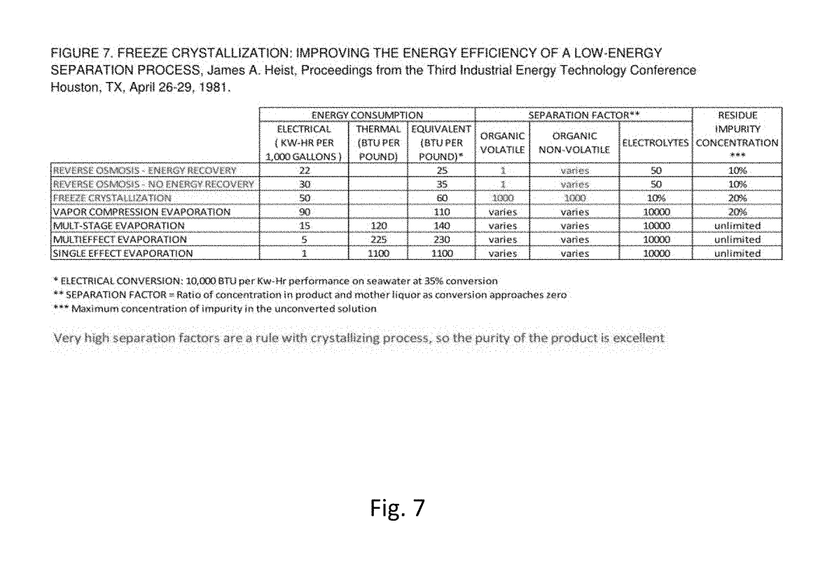

FIG. 7 shows that although more power is consumed by freeze crystallization, freeze crystallization applies where strong isolation of the impurity is required. The apparent power disadvantage can be overcome by using Reverse Osmosis upstream of the freeze crystallization process so that the freeze crystallization processes the brine coming from the Reverse Osmosis.

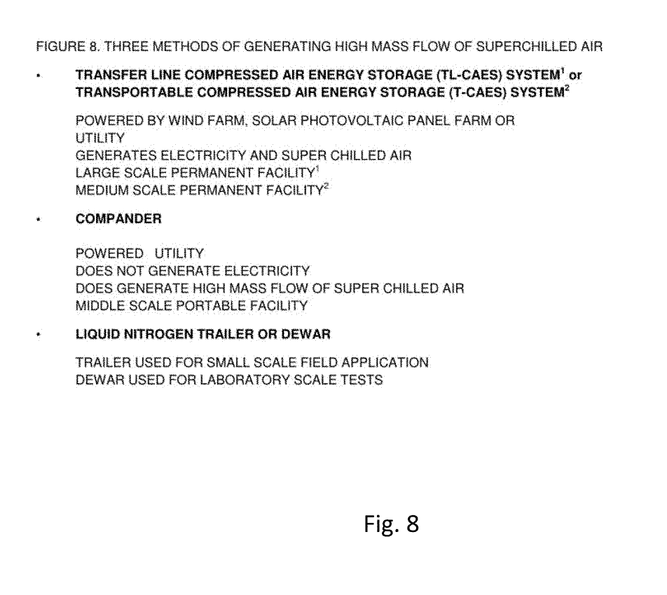

FIG. 8 shows the two methods for obtaining the high mass flow of super chilled air at −175° F., namely TL-CAES and Compander methods. The TL-CAES system not only stores energy but it also transfers energy so that unsightly high voltage power lines are not needed between the power source and where the electricity is finally used. The use of a wind farm or photovoltaic panel farm as the power source makes this system completely green, and no fuel is burned. The TL-CAES system not only supplies electricity to the end-user but also the high mass flow of air at −175° F. This system is viable at 1 to 10 MW and days of power delivery. The scenario involves a power source about 3 or more miles away from the user so that a high air pressure pipe line is used to supply the compressed air to the user's turboexpander/generator setup.

The T-CAES system only stores energy but does not transfer energy. The use of a wind farm or photovoltaic panel farm as the power source makes this system completely green . . . no fuel is burned. The T-CAES system not only supplies electricity to the end-user but also the high mass flow of air at −175° F. This system is viable at 1 to 10 MW and for about 4 hours of power delivery. The scenario involves a power source on site with the user so that a manifold of high air pressure vessels is used to supply the compressed air to the user's turboexpander/generator setup.

The Compander is a device driven by about 90 psia compressed air from a low pressure commercial compressor. The Compander is a two-stage configuration of one turbocompressor and turboexpander on a common axle and another turbocompressor and turboexpander on a common axle. The input pressurized air (90 psia and 70° F.) is fed to the first turbocompressor and heat exchanger and then to the second turbocompressor and heat exchanger. The initial flow of air through the turbocompressor also feed through their respective turboexpander. It takes a few seconds as all the rotary machinery accelerates to the free-spooling rotary speed. At that point only a high mass of super-chilled air at −175° F. is generated. No electricity is generated. The only driver for the system is utility or GenSet power driving a low pressure air compressor with 90 psia pressure output.

The above two systems are capable of supporting at least 95,000 gallons per day of wastewater purification. The dewar-size and trailer-size liquid nitrogen driven system is intended to support a small but highly instrumented EFCSC facility. The objective of this permanent facility is to determine the design of the full scale facilities that are required to support each new client. Each new client is expected to have his own pollutant and initial pollutant concentration that he requires removed to meet specified water purity.

FIG. 9 shows the T-CAES system as well as the TL-CAES system wherein power from a wind farm or a solar photovoltaic panel farm powers an air compressor that pressurizes a manifold of tanks for the T-CAES system or a long pressurized pipeline to 1,200 psig when the wind is blowing or the sun is shining.

When the wind is not blowing and the sun is not shining but electrical power is needed the pressure vessel supplies a constant 200 psig to the turboexpander/generator. The generator (driven by the turboexpander) supplies the required electricity and the turboexpander exhaust produces a high mass flow of super chilled air at −175° F.

It is the recent development of the T-CAES system and TL-CAES system that has made available this extremely cold air at such a high mass flow. And it is this by-product that drives the EFCSC facility. Up to this point only cold temperatures associated with conventional refrigerators or with Canadian winters such as those close to −10° F. rather than what is now available as −175° F.

When the exhaust air from the EFCSC facility is −20° F., that air when ice particles are removed, is sent to a GenSet as intake air for a 30% reduction in natural gas consumption for the same electrical power output.

In one system configuration the GenSet runs with normal consumption of natural gas. On the other hand, when supplied with −20° F. intake air it consumes 30% less natural gas. The GenSet electricity is used to supply the electrical power that drives a Compander that supplies cold air to the EFCSC facility to purify water.

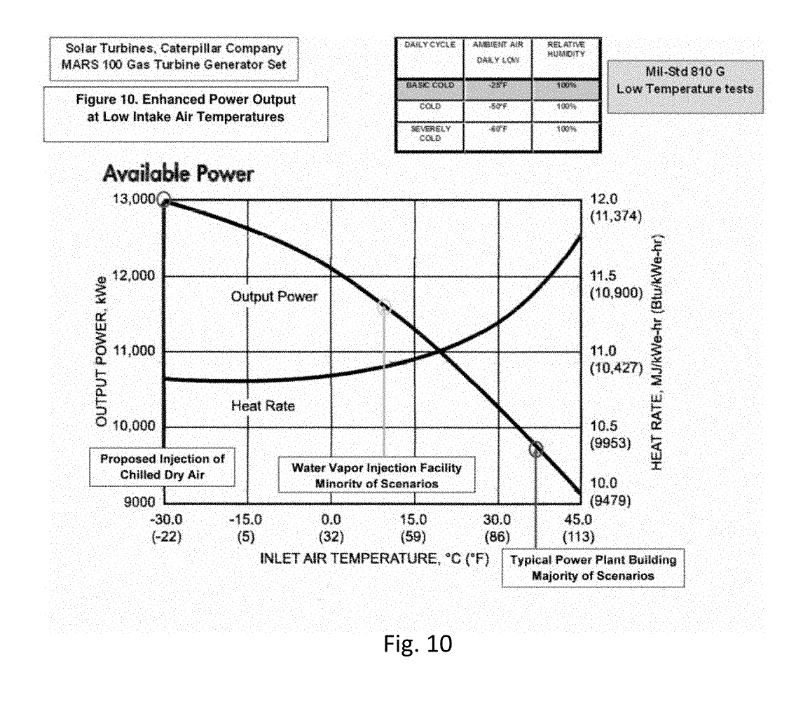

FIG. 10 shows the dependence of electrical power output on the intake air temperature for a MARS 100 GenSet manufactured by Caterpillar Solar Corporation. When the intake air to the turbocompressor is less dense (high air temperature) there is an increase in the power required to deliver the given mass flow of air to the combustion chamber. The turbocompressor operates on a volumetric flow basis but the combustion chamber operates on a mass flow basis.

Typical large GenSets operate in an enclosed Power Building that has indoor air temperatures of the order of 100° F. so that the MARS 100 GenSet will generate 9,700 kW of electrical power. Power system engineers are aware of this power loss so they chill the intake air via several types of cooler devices and refrigeration devices so that the intake air is reduced to 47° F. rather than using 100° F. to achieve 11,700 kW of electrical power output for the same natural gas consumption. This represents the current state of the art. However, Mil-Std 810G requires that GenSets used in the arctic operate at −25° F. Thus there is no reason the GenSet should be driven by intake air at 47° F. This operation has not yet been performed commercially but described herein. The operation at −20° F. will result in 13,000 kW electrical power output at the same natural gas consumption.

FIG. 11 shows the use of a Compander to generate the high mass flow of super-chilled air at −175° F. The two-stage, free-spooling Compander is driven by a conventional air compressor that usually supplies “house-air” at 90 psia for pneumatic tools. The electricity for the conventional air compressor is supplied by a GenSet when there is no utility power source nearby.

Note that the high mass flow of air at −20° F. from the ECFSC facility is used to gain the high efficiency operation of the GenSet as seen in FIG. 9.

In this example the output air that was laden with ice crystals is centrifuged prior to feeding the air to the high speed impeller blades of the input air to the turbine-driven compressor. The larger than 10 micron diameter ice particles are centrifuged using a 135 degree turn in the feed ducting while the smaller than 10 micron diameter ice articles are carried by the airflow streamlining through the open channel between the blades so there is no impact of ice particles on the blades.

It is important to centrifuge all ice particles from the −20° F., particle laden air with ice particles greater than 10 microns in diameter prior to feeding the intake air to the turbocompressor. The high speed impeller blades of the turbine would be eroded by the continuous impact of these ice particles.

The ice particles smaller than 10 microns in diameter will track the intake air streamlines even though there is a curved flight trajectory between the blades. These particles will melt and evaporate in the sweep of the turbine blades as the air is heated by compression. This further cooling aids the efficiency of the compression process.

FIG. 12 shows a laboratory facility that is highly instrumented to observe the behavior of the crystallization chamber, namely monitoring: (1) Injection zone at the top of the EFCSC facility to note wastewater droplet size development and distance to achieve terminal velocity of the droplet, (2) Mid-Height zone of the ECSC facility to provide photomicrographs of the falling particle as it freezes to note the migration of the brine from inside the core of the frozen platelet of fresh water ice, (3) Bottom zone of EFCSC facility to provide photographs of the accumulating snow mass and the draining of the brine through the porous snow mass, (4) Snow mass trapped on mesh of the perforated basket, (5) Salt crystals trapped on the fine mesh located under the snow mass, and (6) Measure the electrical conductance of the brine collected at the very bottom of the EFCSC facility.

With reference to FIG. 12, an elongated chamber 102, having a top 102a and bottom 102b, has a wastewater nozzle 104 at the top 102a, and a perforated basket-type accumulator 106 at the bottom 102b for accumulating the ice particles. At or near the top 102a of the chamber is/are one or more nitrogen vents 118 to permit nitrogen gas to escape. Below the accumulator 106 at the bottom 102b is a collector 120 for the drained brine, wherein the collector 120 has a fine grating 122 over it. In an embodiment, salt 124 may be positioned between the accumulator 106 and collector 120, on top of the collector's grating 122. In between the top 102a and bottom 102b of the chamber 102 is a chilled air ingress 108. The source of chilled air (gaseous nitrogen) may be a liquid nitrogen source 112 comprising a liquid nitrogen dewar 114 and/or gaseous nitrogen 116 at room temperature. In use, the chilled air or nitrogen passes into the chamber 102 and is directed upwardly, in an opposite direction to the wastewater drops 126 being emitted downwardly from the nozzle 104. As the chilled air passes the droplet, it reduces the temperature of the droplet which freezes, partially or wholly, and drops into the accumulator 106. The brine leaves the accumulator through the perforated bottom and drips into the salt 124 where it becomes more saline. The brine 129 comes to rest in the collector 120.

In order to observe the operation and effects of the system, a video camera 130 is positioned to view into the accumulator 106 to view the detail of the appearance of the frozen droplets. At or near the top 102a, below the nozzle 104, are a light projector 132 and a digital video or still camera 134, wherein the field of view of the camera 134 is illuminated by the light projector 132. In an embodiment, the opposite side 102c of the chamber from the camera is painted black to produce greater contrast on the video image. The inside surfaces of the camera and light projector may also be painted black. A window lens 138 separates the light projector 132 from the interior of the chamber 102. A light polarizer 136 is located between the light projector 132 and the window lens 138, which is used to filter out all the scattered light, reflections and glare coming from sources other than the target of interest. In an embodiment, a dry nitrogen source 139 is located between the window lens and the interior of the chamber to prevent any moist air coming into contact with windows or lenses and prevent the fogging of windows and lenses, obstructing viewing of the target. A window lens 140 also separates the camera 134 from the chamber 102. A light polarizer 142 is located between the camera 134 and the window lens 140, and is used to filter out all the scattered light, reflections and glare coming from sources other than the target of interest. In an embodiment, a dry nitrogen source 144 is located between the window lens and the interior of the chamber 102 to dry air coming into contact with windows or lenses.

The light projector 132 has a number of modes, wherein it may illuminate by a series of flashes, timed to reveal a series of still photos, or timed to reveal ice formation, or timed to reveal salt crystallization. The camera 134 may also have a number of photo settings to permit accurate observation of the droplets in flight. In order to determine the nitrogen's upward velocity, plastic beads may be dropped within the chamber 102 and observed.

If complete separation of the pollutant from the wastewater is shown by the electrical conductance of the concentrated brine, a series of wash procedures will be performed and fine-tuned to develop an optimum wash procedure.

Consider that this facility will use a predetermined concentration of pollutant in the wastewater and will measure the concentration of the final brine concentration so that separation efficiency will be measured. For simple salts where concentrations of 10% to 20% starting solution will require simple instrumentation to determine if the final concentration of the solution is about 100 ppm. For the more toxic pollutants the initial range may be in parts per million (ppm) and need to be brought to parts per billion (ppb), the instrumentation is more complex. Furthermore safety handling and disposal rules must be followed.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A wastewater purifier comprising:
a. a chamber having an upper ingress end and a lower drain end;
b. one or more wastewater nozzles connected to a wastewater source positioned near the ingress end, to produce wastewater droplets;
c. a chilled air ingress positioned near the ingress end, connected to a chilled air source, positioned to permit the chilled air to mix with the wastewater droplets;
d. a perforated accumulator near the drain end adapted to collect frozen droplets;
e. a drain below the accumulator configured to provide an exit for liquid wastewater; and
f. an egress for the chilled air near the drain end.

2. The wastewater purifier of claim 1, further comprising a housing around the chamber, comprising at least a partial double-wall around the chamber, the double wall defining an egress path, wherein the egress path is connected to the egress.

3. The wastewater purifier of claim 1, wherein the nozzle is configured to provide droplets of a predetermined size.

4. The wastewater purifier of claim 1, further comprising a fresh water nozzle directed to the interior of the accumulator, the fresh water nozzle adapted to spray fresh water on frozen droplets collected within the accumulator.

5. The wastewater purifier of claim 1, wherein the chilled air source is selected from the group consisting of T-CAES turboexpander, TL-CAES turboexpander, compander and liquid nitrogen (LN2) trailer.

6. The wastewater purifier of claim 1, wherein the wastewater droplets have a flight time of 3.75 to 7.05 seconds from being emitted from the nozzle to dropping into the receptacle.

7. The wastewater purifier of claim 1, further comprising salt between the accumulator and the drain.

8. A wastewater purifier, comprising:
a. an elongated flow chamber having an upper portion and lower portion;
b. one or more wastewater nozzles positioned near the upper portion;
c. one or more egress vents positioned near the upper portion;
d. a perforated accumulator at the bottom of the chamber; and
e. a chilled air ingress connected between the upper and lower portions, the ingress connected to a chilled air source.

9. The wastewater purifier of claim 8, wherein the one or more nozzles produce droplets of a predetermined size and project the droplet downwardly.

10. The wastewater purifier of claim 8, further comprising a collector positioned below the accumulator, wherein brine from the accumulator is collected in the collector.

11. The wastewater purifier of claim 8, further comprising a fresh water nozzle directed to the interior of the accumulator, the fresh water nozzle adapted to spray fresh water on frozen droplets collected within the accumulator.

12. The wastewater purifier of claim 8, wherein a chilled air flow is from the chilled air ingress, up the flow chamber and out the one or more egress vents.

13. The wastewater purifier of claim 8, further comprising salt between the accumulator and the collector.

14. The wastewater purifier of claim 8, wherein the collector is connected to a drain.

15. The wastewater purifier of claim 8, wherein the chilled air source is selected from the group consisting of T-CAES turboexpander, TL-CAES turboexpander, compander and liquid nitrogen (LN2) trailer.

16. The wastewater purifier of claim 8 further comprising a video camera positioned to view into the accumulator.

17. The wastewater purifier of claim 8 further comprising a light projector directed into the elongated flow chamber to illuminate a portion of the interior of the flow chamber, and a camera directed into the illuminated portion of the interior of the flow chamber configured to capture images of freezing droplets.

18. The wastewater purifier of claim 8 the light projector and camera each further comprising a lens, wherein each of the light projector and camera are separated from the interior of the flow chamber by the lenses.

19. The wastewater purifier of claim 8 further comprising a dry nitrogen source between the lens and the interior of the flow chamber, to prevent moisture from collecting on the lens.

20. The wastewater purifier of claim 8 further comprising a light polarizer positioned between the camera and the lens configured to filter out scattered light and reflections coming from sources other than the light projector.
